(19) United States
(12) Patent Application Publication
(10) Pub. No.: US 2015/0130285 A1
(43) Pub. Date: May 14, 2015

(54) PORTABLE TRANSMITTER FOR WIRELESS POWER TRANSMISSION

(71) Applicant: DVINEWAVE INC., SAN RAMON, CA (US)

(72) Inventors: Michael A. Leabman, San Ramon, CA (US); Gregory Scott Brewer, Livermore, CA (US)

(73) Assignee: DVINEWAVE INC., SAN RAMON, CA (US)

(21) Appl. No.: 14/075,376

(22) Filed: Nov. 8, 2013

(51) Int. Cl. H01F 38/14

(52) U.S. Cl. CPC H01F 38/14
USPC 307/104

(57) ABSTRACT

The present disclosure may provide a portable wireless transmitter which may be used to provide wireless power transmission (WPT) while using suitable WPT techniques such as pocket-forming. Portable wireless transmitter may be intended for providing power to a variety of devices in applications which demand portability or mobility for the transmitter. In some embodiments, transmitters may include one or more antennas connected to at least one radio frequency integrated circuit (RFIC) and one microcontroller. In other embodiments, transmitters may include a plurality of antennas, a plurality of RFIC or a plurality of controllers. In addition, portable wireless transmitters may include communications components which may allow for communication to various electronic equipment including phones, computers and others.

### CROSS-REFERENCES TO RELATED APPLICATIONS

The present disclosure is related to U.S. Non-Provisional patent application Ser. No. 13/891,430 filed May 10, 2013, entitled “Methodology For Pocket-forming”; Ser. No. 13/891,455 filed May 10, 2013, entitled “Transmitters For Wireless Power Transmission”; and Ser. No. 13/925,469 filed Jun. 24, 2013, entitled “Methodology for Multiple Pocket-Forming” the entire contents of which are incorporated herein by these references.

### FIELD OF INVENTION

The present disclosure relates to electronic transmitters, and more particularly to portable transmitters for wireless power transmission.

### BACKGROUND OF THE INVENTION

Electronic devices such as laptop computers, smartphones, portable gaming devices, tablets and so forth may require power for performing their intended functions. This may require having to charge electronic equipment at least once a day, or in high-demand electronic devices more than once a day. Such an activity may be tedious and may represent a burden to users. For example, a user may be required to carry chargers in case his electronic equipment is lacking power. In addition, users have to find available power sources to connect to. Lastly, users must plugin to a wall or other power supply to be able to charge his or her electronic device. However, such an activity may render electronic devices inoperable during charging. Current solutions to this problem may include inductive pads which may employ magnetic induction or resonating coils. Nevertheless, such a solution may still require that electronic devices may have to be placed in a specific place for powering. Thus, electronic devices during charging may not be portable.

For the foregoing reasons, there is a need for a wireless power transmission system where electronic devices may be powered without requiring extra chargers or plugs, and where the mobility and portability of electronic devices may not be compromised.

### SUMMARY OF THE INVENTION

The present disclosure provides a portable wireless transmitter which can be utilized for wireless power transmission using suitable techniques such as pocket-forming. Transmitters may be employed for sending Radio frequency (RF) signals to electronic devices which may incorporate receivers. Such receivers may convert RF signals into suitable electricity for powering and charging a plurality of electric devices. Wireless power transmission allows powering and charging a plurality of electrical devices without wires.

A portable wireless transmitter including at least two antenna elements may generate RF signals through the use of one or more Radio frequency integrated circuit (RFIC) which may be managed by one or more microcontrollers. Portable wireless transmitters may receive power from a power source, which may provide enough electricity for a subsequent conversion to RF signal. Such power source may be connected to portable wireless transmitter through a variety of power plugs, which may vary in dependency of the application.

Portable wireless transmitter may be built in a compact size allowing portability of the same. In addition, portable wireless transmission may allow high resistance against water, shocks, vibration and other rough conditions. Solid state circuits may be used in order to increase reliability of portable wireless transmitter.

In an embodiment, a portable wireless transmitter including a power plug intended to connect portable wireless transmitter to one or more power outlet on the walls, floors, ceilings and/or electric adapters is provided.

In a further embodiment, a portable wireless transmitter including a plurality of power plugs intended to connect portable wireless transmitter to a variety of power sources and/or electric adapters is provided.

Portable wireless transmitter provided in the present disclosure, as well as possible implementation schemes may provide wireless power transmission while eliminating the use of wires or pads for charging devices which may require tedious procedures such as plugging to a wall, and may turn devices unusable during charging. In addition, electronic equipment may require less components as typical wall chargers may not be required. In some cases, even batteries may be eliminated as a device may fully be powered wirelessly. Furthermore, capability of being mobile or portable may allow the capacity of wireless power transmission in different locations regardless the condition and/or the time.

Numerous other aspects, features and benefits of the present disclosure may be made apparent from the following detailed description taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates a wireless power transmission example situation using pocket-forming.

FIG. 2 illustrates a component level embodiment for a portable transmitter.

FIG. 3 illustrates a portable transmitter where a power plug may be included, which may connect portable wireless transmitter to one or more power outlet on the walls, floors, ceilings and/or electric adapters.

FIG. 4 illustrates a transmitter where a plurality of power plugs may be included, which may be intended to connect portable wireless transmitter to a variety of power sources and/or electric adapters.

### DETAILED DESCRIPTION OF THE DRAWINGS

### Definitions

“Pocket-forming” may refer to generating two or more RF waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain adjusted with respect to other RF signals, substantially all of which pass through one or more RF antenna such that focused RF signals are directed to a target.

“Receiver” may refer to a device including at least one antenna element, at least one rectifying circuit and at least one power converter, which may utilize pockets of energy for powering, or charging an electronic device.

“Adaptive pocket-forming” may refer to dynamically adjusting pocket-forming to regulate power on one or more targeted receivers.

### DESCRIPTION OF THE DRAWINGS

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

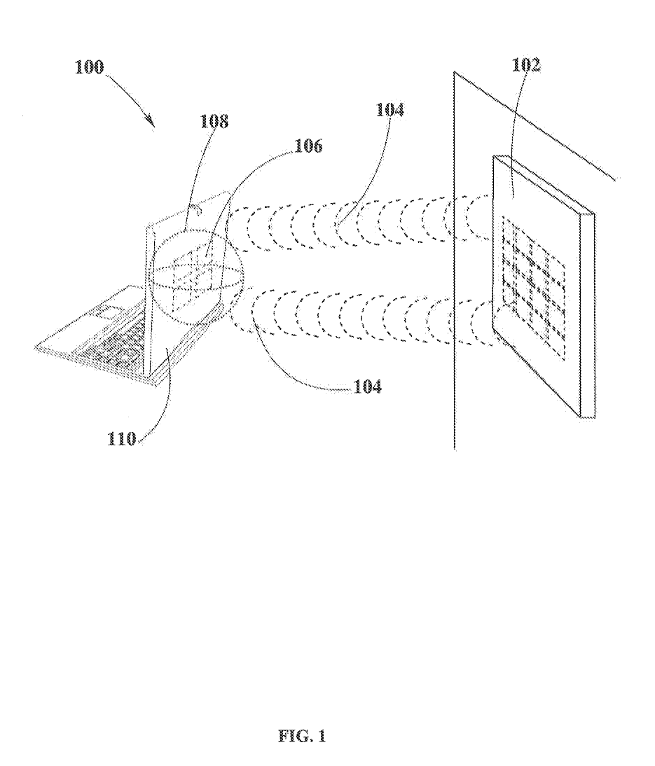

FIG. 1 illustrates wireless power transmission 100 using pocket-forming. A transmitter 102 may transmit controlled Radio RF waves 104 which may converge in 3-d space. These Radio frequencies (RF) waves may be controlled through phase and/or relative amplitude adjustments to form constructive and destructive interference patterns (pocket-forming). Pockets of energy 108 may be formed at constructive interference patterns and can be 3-dimensional in shape whereas null-spaces may be generated at destructive interference patterns. A receiver 106 may then utilize pockets of energy 108 produced by pocket-forming for charging or powering an electronic device, for example a laptop computer 110 and thus effectively providing wireless power transmission 100. In other situations there can be multiple transmitters 102 and/or multiple receivers 106 for powering various electronic equipment for example smartphones, tablets, music players, toys and others at the same time. In other embodiments, adaptive pocket-forming may be used to regulate power on electronic devices.

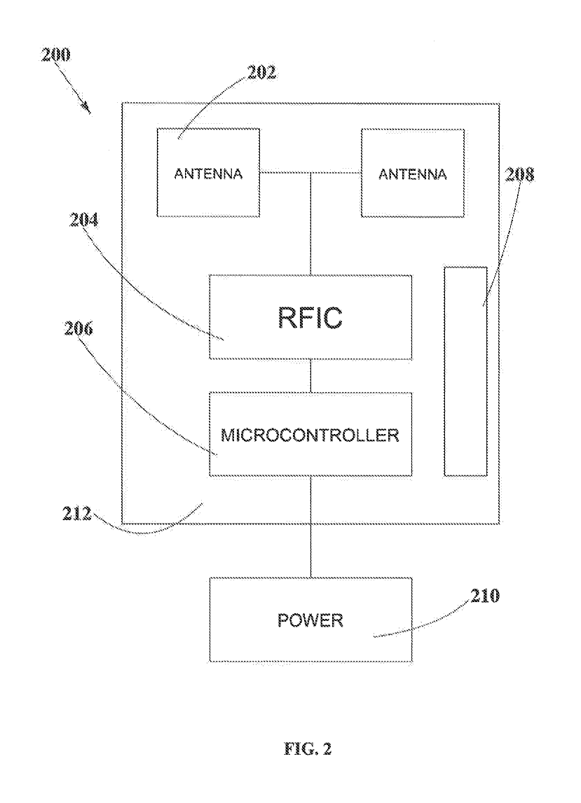

FIG. 2 depicts a block diagram of a portable wireless transmitter 200, which may include one or more antenna elements 202, one or more Radio frequency integrated circuit (RFIC) 204, one or more microcontroller 206, a communication component 208, a power source 210 and a housing 212, which may allocate all the requested components for portable wireless transmitter 200. Components in portable wireless transmitter 200 may be manufactured using meta-materials, micro-printing of circuits, nano-materials, and the like. RFIC 204, microcontrollers 206 and communication component 208 may be miniaturized. Thus, portability of portable wireless transmitter 200 may increase.

Portable wireless transmitter 200 may be responsible for the pocket-forming, adaptive pocket-forming and multiple pocket-forming through the use of the components mentioned in the foregoing paragraph. Portable wireless transmitter 200 may send wireless power transmission to one or more receivers 106 in form of radio signals, such signals may include any radio signal with any frequency or wavelength.

Antenna elements 202 may include suitable antenna types for operating in frequency bands such as 900 MHz, 2.5 GHz or 5.8 GHz as these frequency bands conform to Federal Communications Commission (FCC) regulations part 18 (Industrial, Scientific and Medical equipment). Antenna elements 202 may operate in independent frequencies, allowing a multichannel operation of pocket-forming.

In addition, antenna elements 202 may have at least one polarization or a selection of polarizations. Such polarization may include vertical pole, horizontal pole, circularly polarized, left hand polarized, right hand polarized, or a combination of polarizations. The selection of polarizations may vary in dependency of portable wireless transmitter 200 characteristics. In addition, antenna elements 202 may be located in various surfaces of portable wireless transmitter 200.

Antenna elements 202 may operate in single array, pair array, quad array and any other suitable arrangement, which may be designed in accordance with the desired application. Furthermore, portable wireless transmitter 200 may include a reduced number of antenna elements 202, such as 4 or 16 antenna elements 202, which may have the same or smaller sizes than normal transmitters 102.

RFIC 204 may include a plurality of RF circuits which may include digital and/or analog components, such as, amplifiers, capacitors, oscillators, piezoelectric crystals and the like. RFIC 204 may control features of antenna elements 202, such as gain and/or phase for pocket-forming and manage it through direction, power level, and the like. The phase and the amplitude of pocket-forming in each antenna elements 202 may be regulated by the corresponding RFIC 204 in order to generate the desired pocket-forming and null steering. In addition RFIC 204 may be connected to microcontroller 206, which may include a digital signal processor (DSP), PIC-Class microprocessor, central processing unit, computer and the like. Microcontroller 206 may control a variety of features of RFIC 204 such as, time emission of pocket-forming, direction of the pocket-forming, bounce angle, power intensity and the like. Furthermore, microcontroller 206 may control multiple pocket-forming over multiple receivers 106 or over a single receiver 106. Furthermore, portable wireless transmitter 200 may allow distance discrimination of wireless power transmission 100.

In addition, microcontroller 206 may manage and control communication protocols and signals by controlling communication component 208. Microcontroller 206 may process information received by communication component 208 which may send and receive signals to and from a receiver 106 in order to track it and concentrate the pocket of energy 108 on it. In addition, other information may be transmitted from and to receiver 106; such information may include authentication protocols among others. Communication component 208 may include and combine Bluetooth technology, infrared communication, WI-FI, FM radio among others. Microcontroller 206 may determine optimum times and locations for pocket-forming, including the most efficient trajectory to transmit pocket forming in order to reduce losses because obstacles. Such trajectory may include direct pocket-forming, bouncing, and distance discrimination of pocket-forming.

Portable wireless transmitter 200 may be fed by a power source 210 which may include AC or DC power supply. Such power source 210 may be connected to portable wireless power portable wireless transmitter 200 through a power plug. Voltage, power and current intensity provided by power source 210 may vary in dependency with the required power to be transmitted. Conversion of power to radio signal may be managed by microcontroller 206 and carried out by RFIC 204, which may utilize a plurality of methods and components to produce radio signals in a wide variety of frequencies, wavelength, intensities and other features. As an exemplary use of a variety of methods and components for radio signal generation, oscillators and piezoelectric crystals may be used to create and change radio frequencies in different antenna elements 202. In addition, a variety of filters may be used for smoothing signals as well as amplifiers for increasing power to be transmitted.

Furthermore, RFIC 204, microcontroller 206, communication component 208 and the rest of electronic components may be built in solid state circuits for increasing reliability in portable wireless transmitter 200. Others techniques for increasing reliability of electronic components may be used.

Portable wireless transmitter 200 may emit pocket-forming with a power capability from few watts to over hundreds of watts. Each antenna may manage a certain power capacity. Such power capacity may be related with the application.

In addition to housing 212, may allow the components mentioned above in an ultra-compact structure, such structure may be slim, flat and the like.

Antenna elements 202, RFIC 204 and microcontrollers 206 may be connected in a plurality of arrangements and combinations, which may depend on the desired characteristics of portable wireless transmitter 200.

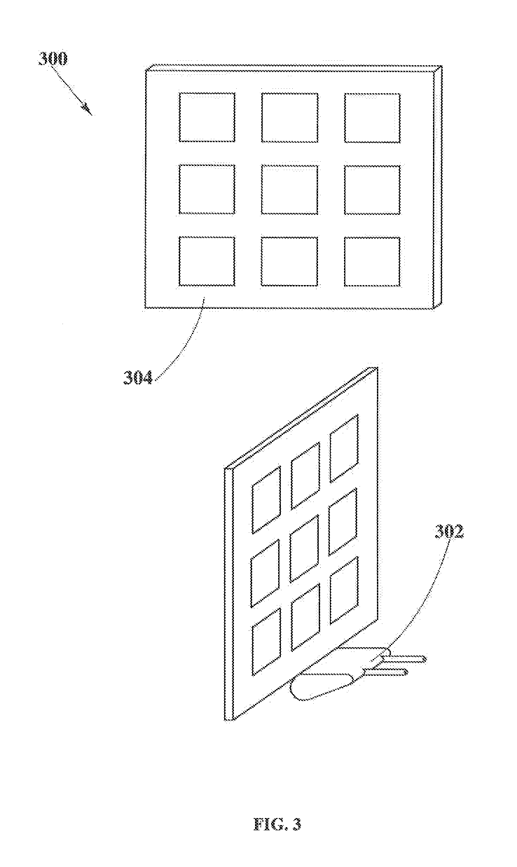

FIG. 3 depicts a portable wireless transmitter 300 in a front view and a rear view. Portable wireless transmitter 300 may include antenna elements 202 in a flat arrangement. Portable wireless transmitter 300 may be connected to a power source 210 through one or more power plug 302, such power plug 302 may comply with the standard of each country and/or region. Power plug 302 may be intended to connect portable wireless transmitter 300 to one or more power outlet on the walls, floors, ceilings and/or electric adapters.

In order to increase portability of portable wireless transmitter 300, power plug 302 may be foldable, telescopic, ultra-compact and the like. Such features may reduce size for transportation and for pocketing.

Portable wireless transmitter 300 may be built into a housing 304, which may provide additional protection against water, high temperature, sand, bugs, shocks, vibration and other rough conditions which may be a threat to the integrity of portable wireless transmitter 300. Thus, housing 304 may be made using a plurality of materials which may provide the forgoing characteristics.

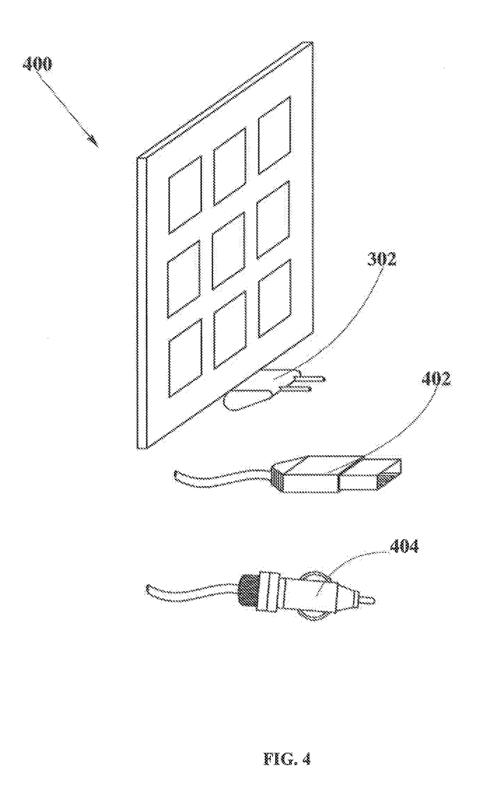

FIG. 4 depicts a portable wireless transmitter 400 showing different power plugs 302, such power plug 302 may include a USB adapter 402, and a cigarette lighter plug 404. USB adapter 402 may be used for receive power from any device having a USB port. These devices may include, laptops, Smart TVs, tablets and the like. Cigarette lighter plug 404 may be used for receive power from any cigarette lighter socket, such as the used in cars. In addition, portable wireless transmitter 400 may include a variety of power plugs 302, such power plugs 302 may vary in dependency with the final application.

While various aspects and embodiments have been disclosed herein, other aspects and embodiments may be contemplated. The various aspects and embodiments disclosed herein are for purposes of illustration and are not intended to be limiting, with the true scope and spirit being indicated by the following claims.

Having thus described the invention, we claim:

1. A method for wireless power transmission by a portable transmitter, comprising:
generating two or more RF waves from the transmitter with at least two RF transmit antennas connected to a radio frequency integrated circuit;
managing the generation of RF waves by at least one microcontroller connected to the radio frequency integrated circuit;
forming controlled constructive and destructive interference patterns from the generated RF waves by the radio frequency integrated circuit controlled by the microcontroller;
accumulating energy or power in the form of constructive interference patterns from the RF waves to form pockets of energy;
converging the pockets of energy in 3-d space to a targeted electronic device; and
arranging the two antennas in an optimal array for charging or powering the targeted electronic device with the pockets of energy.

2. A method for wireless power transmission by a portable transmitter, comprising the steps of:
housing solid state circuits including an RF integrated circuit connected to at least two antennas in an enclosure resistant to water, shocks, vibration or adverse environmental conditions to increase the reliability of the portable transmitter;
providing a power source through a variety of power plugs connected to the solid state circuits in the enclosure to generate RF waves from the RF integrated circuit;
broadcasting the RF waves over the at least two antennas;
controlling the generated RF waves by the solid state circuits and the RF integrated circuit to define pocket-forming for converging the RF waves in 3-d space to form pockets of energy from the RF waves; and
arranging the at least two antennas in an optimal array on a surface of the enclosure for wirelessly charging or powering a targeted electronic device with the pockets of energy.

3. The method for wireless power transmission by a portable transmitter of claim 2, wherein the power plug attached to the enclosure and the solid state circuits is connected to a power outlet on a wall, floor, ceiling or other location.

4. The method for wireless power transmission by a portable transmitter of claim 2, further including the step of adaptive pocket-forming to dynamically adjust the pocket-forming in order to regulate power or charging on one or more targeted electronic device.

5. The method for wireless power transmission by a portable transmitter of claim 2, wherein the pocket-forming is controlled through phase or gain adjustments of the RF waves to form constructive and destructive interference patterns.

6. The method for wireless power transmission by a portable transmitter of claim 2, further includes the step of operating the antennas in independent frequencies to allow a multichannel operation of pocket-forming.

7. The method for wireless power transmission by a portable transmitter of claim 5, wherein the values of phase and gain are used by a microprocessor in the solid state circuits to adjust transmitter antennas to form pockets of energy used to charge or power the electronic device.

8. The method for wireless power transmission by a portable transmitter of claim 2, wherein components of the solid state circuits are manufactured using meta-materials, micro-printing of solid state circuits, nano-materials to miniaturize and increase the portability of the transmitter.

9. The method for wireless power transmission by a portable transmitter of claim 2, wherein the antennas include antenna elements for operating in frequency bands of 900 MHz, 2.5 GHz or 5.8 GHz.

10. The method for wireless power transmission by a portable transmitter of claim 7, wherein the microprocessor determines appropriate adjustments for phase and gain in the transmitter antennas for the pocket-forming or for an adaptive pocket-forming or for a multiple pocket-forming to form pockets of energy at the appropriate locations based on the targeted electronic device location.

11. The method for wireless power transmission by a portable transmitter of claim 2, wherein the electronic device includes a laptop computer, a smartphone, a tablet, a music player, toys and wireless security cameras.

12. The method for wireless power transmission by a portable transmitter of claim 9, wherein the antenna elements include at least one polarization or a selection of polarizations to further include vertical pole, horizontal pole, circularly polarized, left hand polarized, right hand polarized, or a combination of polarizations where the antenna elements are configured to be located within the various surfaces of the wireless transmitter.

13. A wireless portable transmitter for power transmission, comprising:
a housing for embedding analog or digital electrical circuits of the portable transmitter,
at least two antennas connected to the electrical circuits;
a RF integrated circuit connected to the electrical circuits;
a microprocessor connected to the RF integrated circuit to control RF waves generated by the RF integrated circuit and to broadcast the controlled RF waves through the at least two antennas for pocket-forming to form pockets of energy consisting of constructive interference patterns of the controlled RF waves; and
a power plug electrically connected to the electrical circuits within the housing for connecting an external power source to the electrical circuits in order to sustain the pockets of energy necessary for charging or powering an electronic device.

14. The wireless portable transmitter for power transmission of claim 13, wherein the housing is generally a rugged, flat and rectangular shape of a predetermined thickness for protecting the electric circuits from rough environmental conditions.

15. The wireless portable transmitter for power transmission of claim 13, wherein the microprocessor controls the phase and gain of the RF waves to form constructive and destructive interference patterns resulting in the pockets of energy and null-spaces, respectively.

16. The wireless portable transmitter for power transmission of claim 13, wherein the microprocessor calculates the appropriate values of phase and gain to determine appropriate values for all antennas in the transmitter in order to adjust all of the antennas in a transmitter array.

17. The wireless portable transmitter for power transmission of claim 13, wherein each transmitter operates at different frequencies, power intensities and different ranges to power the electronic device.

18. The wireless portable transmitter for power transmission of claim 13, wherein the power plug connected to the transmitter for delivering a power source is foldable, telescopic, ultra-compact, a USB adapter, a cigarette lighter plug or other adapter configuration for a particular country or city code requirements.

19. The wireless portable transmitter for power transmission of claim 13, further including communication circuitry in the transmitter for sending and receiving communication signals from the targeted electronic device in order to track and concentrate pockets of energy on the electronic device and wherein the communication circuitry utilizes Bluetooth, infrared, Wi-Fi, FM radio or Zigbee for the communication protocols.

20. The wireless portable transmitter for power transmission of claim 13, wherein the housing is configured of a predetermined rugged material to withstand water, high or low temperatures, sand, bugs, shocks, vibration and other rough conditions which are a potential threat to the integrity of the portable wireless transmitter.
